(19) United States
(12) Patent Application Publication
(10) Pub. No.: US 2025/0280994 A1
(43) Pub. Date: Sep. 11, 2025

(54) ASSEMBLY FOR ARRANGING IN A KITCHEN AND/OR CATERING DEVICE

(71) Applicant: Welbilt Deutschland GmbH, Eglfing (DE)

(72) Inventors: Georg TIETZE, Kochel am See (DE); Herbert FISCHHABER, Peißenberg (DE); Sebastian SIEBERT, Neubeuern (DE); Hannes WILD, Riegsee (DE)

(21) Appl. No.: 19/059,078

(22) Filed: Feb. 20, 2025

(30) Foreign Application Priority Data
Mar. 7, 2024 (DE) 102024106601.6

(51) Int. Cl. A47J 36/00; B08B 3/04

(52) U.S. Cl. CPC A47J 36/00; B08B 3/04

(57) ABSTRACT

The invention relates to an assembly for arrangement in a kitchen and/or catering device, in particular a cooking device, comprising: at least one solids unit with: a receptacle for inserting a bottle filled with solid additive along an inserting direction, a supply line leading to the receptacle for supplying a fluid dissolving the additive, and a discharge line leading from the receptacle for discharging the fluid together with dissolved additive, and at least one operable bottle fixing device, which is formed in a fixed state to fix the at least one bottle into the respective receptacle and in a released state to release the at least one bottle for removing against the inserting direction.

### CROSS-REFERENCE TO RELATED APPLICATION

This application claims priority to German Patent Application No. 102024106601.6, entitled “Assembly for Arranging in a Kitchen and/or Catering Device” and filed on Mar. 7, 2024, which is expressly incorporated by reference herein in its entirety.

### TECHNICAL FIELD

The invention relates to an assembly for arranging in a kitchen and/or catering device, in particular a cooking device. The invention also relates to the kitchen and/or catering device comprising the assembly.

### BACKGROUND

An assembly of this kind is known from U.S. Pat. No. 10,767,871B2. A cleaning device for commercial cooking devices is described herein. The cleaning device comprises a connecting unit, in particular a receiving neck, for receiving a container with a solids cleaning agent, a liquefaction device for liquefying the solids cleaning agent, optionally using a solvent, and optionally at least a first storage tank.

### SUMMARY

The object of the present invention is to provide an assembly for arranging into a kitchen and/or catering device, which is easy to manufacture and enables low-maintenance operation and reliable cleaning of the kitchen and/or catering device.

The solution to this object is provided by the features of the independent claim. The dependent claims relate to preferred developments of the invention.

The invention shows an assembly for a kitchen and/or catering device. This device is designed in particular for commercial use in catering or for domestic use in a kitchen. The device is preferably a cooking device. For example, the device is designed as a combi-steamer. Alternatively, the device can be designed, for example, as a warming oven or baking oven.

In order to better understand the function and structure of the assembly according to the invention, the structure of the kitchen and/or catering device according to the invention, in which the assembly is used, is first explained. This kitchen and/or catering device comprises a food chamber for the treatment and/or storage of food. The device preferably comprises a housing, wherein the food chamber is arranged within the housing. If the device is designed as a cooking device, the food chamber can also be formed as a cooking chamber. In or at the food chamber, there is preferably a heating/recirculating unit that makes it possible to heat the food chamber and/or to apply recirculating air to it. In particular, the heating/recirculating unit can also be used to generate steam, in order to treat the food in the food chamber by means of steam.

Furthermore, the kitchen and/or catering device comprises a collecting container for storing a liquid washing liquor. The collecting container is preferably arranged below the food chamber. A recirculation is particularly preferred which makes it possible to lead the washing liquor from the food chamber back to the collecting container. The recirculation can be designed as a drain channel leading from the food chamber to the collecting container. The collecting container is connected to the food chamber via a washing liquor line/pipe. This washing liquor line is formed and arranged to supply the washing liquor from the collecting container into the food chamber. A washing liquor pump is particularly preferred, which delivers the washing liquor through the washing liquor line into the food chamber. In particular, the kitchen and/or catering device is arranged to distribute the washing liquor in the food chamber onto the walls of the food chamber in order to clean the food chamber. The washing liquor flows together at the bottom of the food chamber and can be led back into the collecting container via the recirculation described.

To prepare the washing liquor, fresh water is enriched with an additive. This additive may, for example, be a cleaner or a descaling agent or a rinse aid. In the context of the present invention, it is arranged that the additive is not liquid at room temperature, but is solid and is contained in a bottle. The term “solid” additive is also preferably understood to mean “gel-like” additive. The additive can thus also be described as a non-flowable and non-pourable substance. The additive is stored in the bottle for several cleaning processes, so that only a part of the additive needs to be dissolved from the bottle at any one time.

The kitchen and/or catering device comprises at least one supply line pump for pumping the fluid, preferably the washing liquor, through a supply line of the assembly described below.

The invention shows an assembly for arrangement in the kitchen and/or catering device, in particular as described above. The assembly comprises at least one solids unit.

The solids unit comprises a receptacle for inserting the bottle. This bottle is filled with the solid additive described. The bottle can be inserted into the receptacle in one inserting direction.

Furthermore, the solids unit comprises the aforementioned supply line. This supply line leads to the receptacle and is arranged to supply a fluid, in particular water and the washing liquor described, for dissolving the additive. The bottle is inserted into the receptacle in particular with its opening first. At the rear end of the receptacle is the supply line that sprays the fluid onto the solid in the bottle. For this purpose, the supply line can also project into the bottle.

Furthermore, the solids unit comprises a discharge line that is arranged to discharge the fluid together with the dissolved additive from the receptacle, in particular in the direction of the collecting container described above.

As will be described in more detail below, the assembly defined here can comprise at least two of the solids units, wherein a separate bottle can be inserted into each solids unit. This makes it possible, for example, to insert a rinse aid into the one receptacle and a cleaning agent into the other receptacle.

Furthermore, the assembly comprises a bottle fixing/fastener. As will be described in more detail below, a single bottle fixing is preferably provided for two solids units, i.e. for two bottles. In this case, the bottle fixing is arranged between the two solids units and thus between the two bottles.

The bottle fixing of the assembly is “operable”. This means that the bottle fixing can switch between a fixed state and a released state by an operation—for example, by pressing or releasing the pressure. As will be described in detail, this operation of the bottle fixing is carried out in particular manually by a user, in particular by manually pressing on the bottle fixing and releasing the pressure again.

The bottle fixing is arranged to fix the at least one bottle, preferably two bottles arranged next to each other, in the associated receptacle in the fixed state. Furthermore, the bottle fixing is arranged to release the at least one bottle, in particular the two bottles arranged next to each other, for pulling out against the inserting direction in the released state. If the bottle fixing is operated in the released state, the at least one bottle can be pulled out of its receptacle against the inserting direction. However, if the bottle fixing is in its fixed state, the at least one bottle is fixed in its receptacle and cannot move against the inserting direction. This has a particular advantage if the bottle is not screwed in, but only pushed into the receptacle. When the solid is flushed out through the described supply line with the corresponding water pressure, a force is applied on the bottle against the inserting direction. At a correspondingly high pressure, this can lead to the bottle being pushed out of the receptacle without the bottle fixing.

The bottle fixing preferably comprises a housing. In particular, the housing can be composed of an upper shell and a lower shell. The housing is preferably attached, for example screwed, to the receptacle of the solids unit. If two solids units are used, two receptacles are provided. The bottle fixing can be connected to both receptacles via its housing. Furthermore, it is also preferably provided that the two receptacles of two adjacent solids units are formed in one piece, so that, for example, a plastic component forms both receptacles. In this case, the housing of the bottle fixing can be attached in particular to such a common plastic component.

Furthermore, the bottle fixing preferably comprises at least one holding element. In particular, when the bottle fixing is used between two solids units, two opposite holding elements are provided. The at least one holding element is movably mounted at the housing, in particular rotatably via a pivot bearing.

Furthermore, it is preferably provided that the holding element is arranged to fix the bottle in a form-fitting and/or force-fitting manner in the fixed state. The holding element is particularly preferably arranged to abut against the bottle. In an alternative embodiment, there it is not necessary to provide direct contact between the holding element and the bottle. Therefore, it is also provided that the holding element is arranged to operate a further device in the fixed state, which in turn fixes the bottle in a form-fitting and/or force-fitting manner.

In the preferred embodiment, the bottle fixing is arranged to comprise a blocking element. The blocking element is movably mounted at the housing, in particular linear movably. Even when using two holding elements, in particular only one blocking element is provided. This blocking element is then preferably arranged between the two holding elements and simultaneously operates both holding elements.

In this way, the blocking element is arranged to block a movement of the at least one holding element in the fixed state, in particular to block it in a form-fitting manner. Furthermore, the blocking element is arranged to release the movement of the at least one holding element in the released state.

It is particularly preferred that the blocking element moves the at least one holding element when operating from the released state into the fixed state.

The at least one holding element particularly preferably comprises an outer lever portion and an inner lever portion. The individual holding element is rotatably mounted in the housing between the two lever portions. The inner lever portion is in contact with the blocking element in the fixed state. In particular, the blocking element blocks the inner lever portion in a form-fitting manner.

When two opposing holding elements are used, two inner lever portions project into the interior of the housing. The blocking element is preferably fork-shaped and, in the fixed state, engages around the two inner lever portions, so that the two inner lever portions cannot move outwards, which in turn means that the outer lever portions cannot fold inwards towards the housing.

In a preferred embodiment, there is provided an inclined plane arrangement between the blocking element and the inner lever portion. This is designed to urge the holding element into the bottle-fixing state. Such an inclined plane arrangement describes that the blocking element and the inner lever portion slide against each other, wherein an inclined plane is provided at at least one side of the sliding contact. This allows the inner lever portion to be moved when the blocking element moves into the fixed state.

In the released state, it is possible to move the holding element by pulling out the respective bottle, since this is no longer blocked by the blocking element. However, it is also desirable for the holding element, in particular the outer lever portion, to remain in a position that does not block the reinsertion of a freshly filled bottle. For this purpose, it is preferably provided that the at least one holding element in the released state can be urged into the state releasing the bottle by means of a stop arrangement and/or a return spring and/or a further inclined plane arrangement. Such a stop arrangement and/or return spring and/or further inclined plane arrangement can be used to ensure that the holding element releases the path for inserting of the new bottle.

The stop arrangement preferably comprises a first stop surface at the operating element (which will be described in detail later) and a second stop surface at the holding element. The two stop surfaces come into contact, when the operating element is operated, causing the lever element to be operated in the desired direction.

The return spring can be arranged, for example, as a torsion spring in the section of the pivot bearing of the holding element.

The further inclined plane arrangement preferably describes a sliding contact between an operating element (which will be described in detail later) and the holding element. At least one of the two elements has an inclined plane, so that, when there is a relative movement, the lever element is operated in the desired direction.

Furthermore, it is preferably provided that the bottle fixing comprises a force accumulator. This force accumulator is in particular formed as a spring. The spring is in particular a spiral spring. The force accumulator urges the bottle fixing into the fixed state. When operating from the fixed state to the released state, the force accumulator is thus loaded.

The bottle fixing preferably comprises an operating element. This operating element is arranged to offset the bottle fixing into the released state. In particular, the operating element is arranged in such a way that, when it is operated, it offsets the bottle fixing into the released state and at the same time charges the force accumulator described, wherein preferably no latching or other setting in the released state, but rather the force accumulator relaxes when the operating element is released (pressure is removed), in order to urge the bottle fixing into the fixed state.

It is preferably provided that the operating element is formed and arranged for manual, tool-free operation. In particular, the operating element is operated by pressing it in by hand, in particular with a finger.

It is preferably provided that the operating element is arranged in the housing linear movably.

Preferably, the operating element is arranged to shift the blocking element. To do this, the operating element can rest against the blocking element in order to push the blocking element. However, it is particularly preferred that the blocking element and the operating element are firmly connected to one another or are manufactured together as one part.

It is further preferred that the operating element comprises a head and a connecting portion. In particular, the connecting portion projects from the head up to the blocking element. Preferably, the at least one holding element is arranged between the head and the blocking element. The connecting portion is preferably manufactured in one piece with the head. Furthermore, it is preferably provided that the connecting portion is firmly connected to the blocking element, in particular formed in one piece.

The blocking element preferably comprises an extension/a protrusion, at which the force accumulator, formed as a spiral spring, is arranged.

The bottle fixing particularly preferably comprises a single injection-molded plastic component that forms the operating element together with the head and connecting portion, the blocking element and the extension.

As already mentioned, two solids units are preferably provided, wherein the bottle fixing is arranged between the two solids units and is arranged to simultaneously fix both bottles in the fixed state and/or to simultaneously release both bottles in the released state.

Furthermore, it is preferably provided that the receptacle of the at least one solids unit is arranged for threadless inserting of the bottle. For this purpose, the receptacle preferably comprises a seal, through which an opening section of the bottle can be pushed.

The bottle fixing preferably comprises a locking element. This locking element is arranged to lock the bottle fixing from being operated into the released state in a locked state. Furthermore, the locking element is arranged not to lock the bottle fixing from being operated into the released state in an unlocked state.

Three different locking elements are described, of which preferably only one is used. However, two or all three of the locking elements can also be used at a bottle fixing.

The first locking element is arranged in particular to engage in a movement section of the bottle fixing by means of an electric motor or electromagnetic drive in order to lock the operation of the bottle fixing. In particular, the first locking element can be used to lock a movement of the blocking element and/or the operating element.

It is particularly preferred that the first locking element is controllable for operating into the locked state and/or into the unlocked state. This is done in particular electrically or electronically. For controlling the first locking element, a control device of the kitchen and/or catering device is preferably used. This makes it possible to allow only certain users and/or only in certain states of the device to change the bottles. For example, the locking element can be released by entering a password or code. This ensures that unauthorized or untrained personnel cannot change the bottles.

The second locking element preferably comprises a locking cylinder in the operating element. By turning the locking cylinder with a key, a locking component can be extended out of the operating element into the housing in order to block a movement of the operating element relative to the housing.

The third locking element preferably comprises a padlock that can be hooked onto the operating element between the head and the housing, wherein the shackle of the padlock blocks the operating element from being pushed in.

### BRIEF DESCRIPTION OF THE DRAWINGS

Further details, advantages and features of the present invention will become apparent from the following description of an exemplary embodiment with the drawings. It shows in:

FIG. 1 a perspective front view of an assembly according to an embodiment of the invention,

FIG. 2 a perspective rear view of the assembly according to the embodiment of the invention,

FIG. 3 a plan view with partially hidden elements of the assembly according to the embodiment of the invention,

FIG. 4 a bottle fixing of the assembly according to the embodiment of the invention,

FIG. 5 the bottle fixing from FIG. 4 in the fixed state with the housing open

FIG. 6 the bottle fixing from FIG. 4 in a released state with the housing open

FIG. 7 details of the bottle fixing from FIGS. 4, 5 and 6,

FIG. 8 an exploded view of the bottle fixing from FIG. 4, and

FIG. 9 a schematic side view and front view of a kitchen and/or catering device according to the invention with the assembly according to the embodiment of the invention.

### DETAILED DESCRIPTION

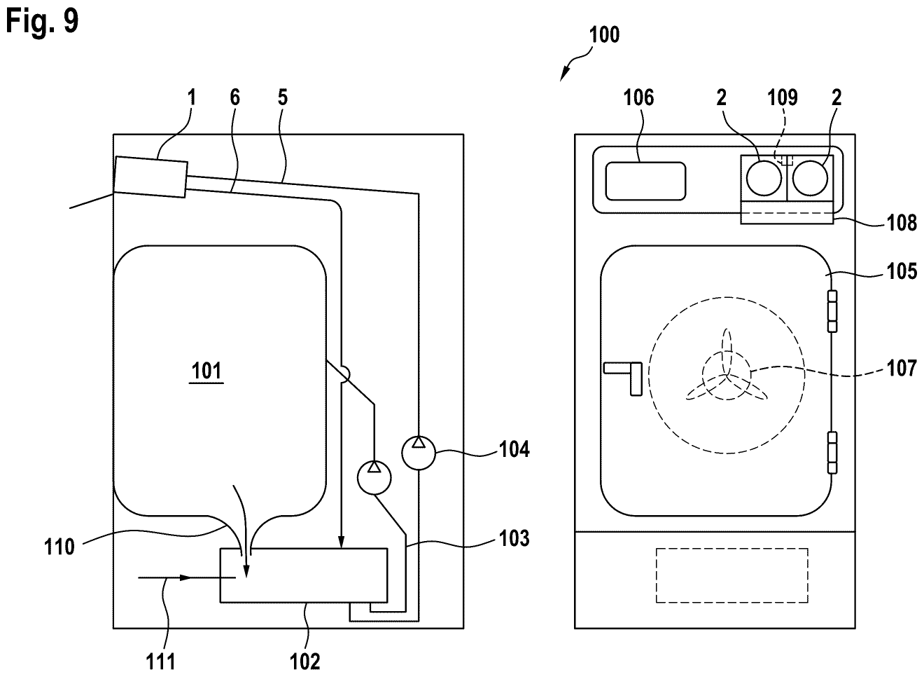

In the following, an assembly 1 according to the invention is first described on the basis of FIGS. 1 to 8. This is used in a kitchen and/or catering device 100, as shown schematically in FIG. 9. Unless otherwise stated, reference is always made to all figures in the following.

In the embodiment shown, the assembly 1 comprises two solids units 2, each with a receptacle 3. In the embodiment shown, the two receptacles 3 of the two solids units 2 are formed by a common injection-molded part.

A bottle 200 filled with solid additive can be inserted along an inserting direction 4 into each receptacle 3.

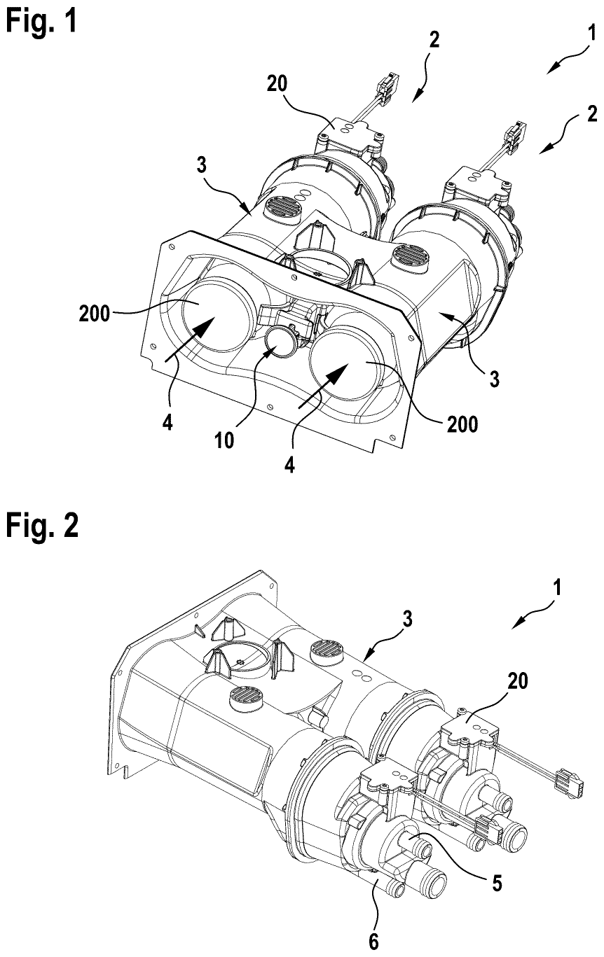

At the rear of the assembly 1, in particular as illustrated in FIG. 2, there is a supply line 5 and a discharge line 6 for each solids unit 2, as explained in the general part of the description.

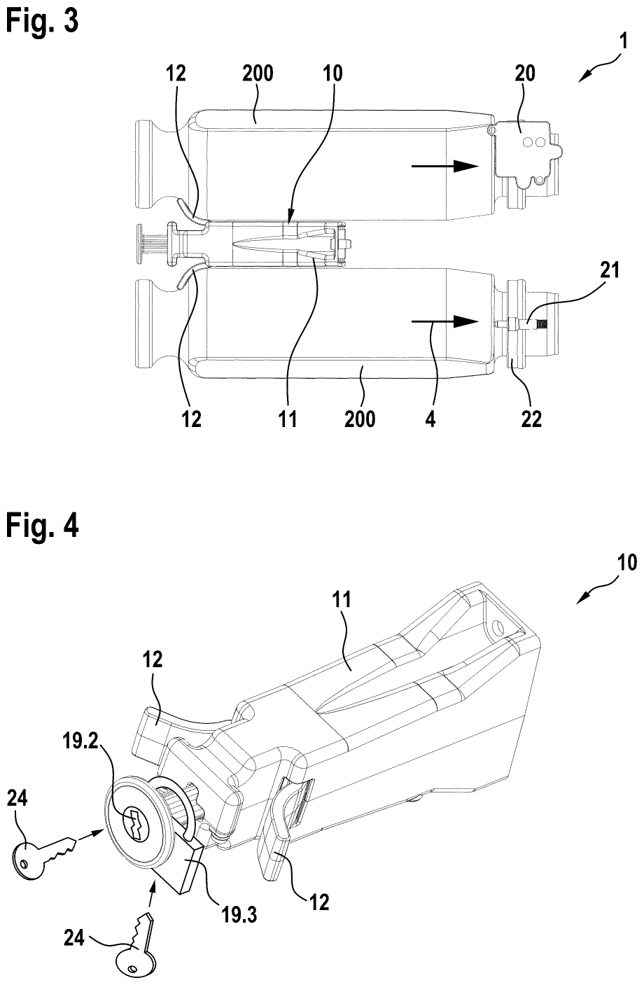

Furthermore, the assembly 1 comprises a bottle fixing 10 for fixing the two bottles 200 in the two solids units 2. FIG. 1 shows the bottle fixing 10 from the front. In the illustration according to FIG. 3, the receptacles 3 of the solids units 2 are hidden, so that it can be seen that the bottle fixing 10 is arranged between the two bottles 200. FIG. 4 shows a perspective view of the bottle fixing 10.

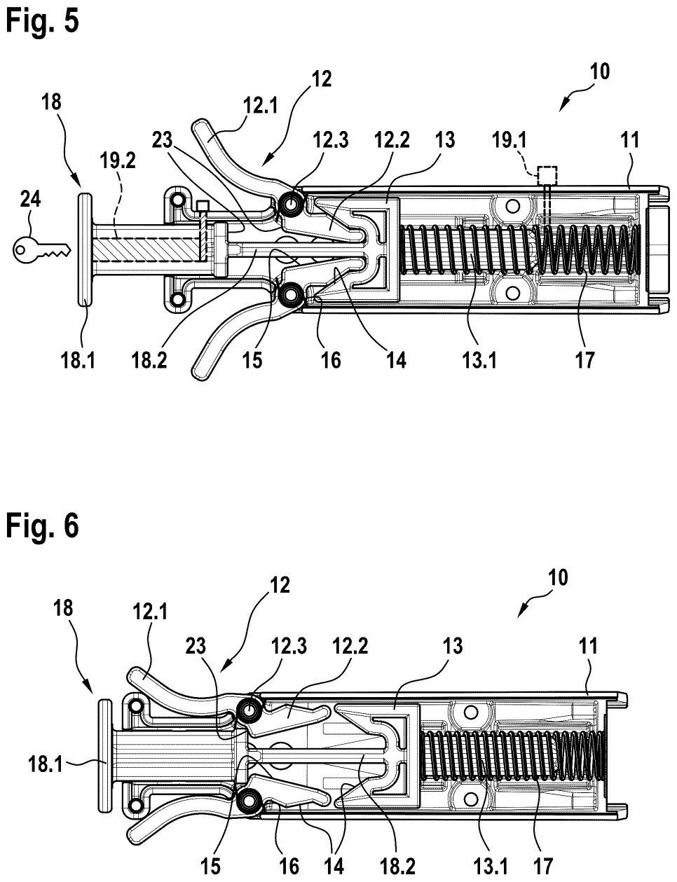

In FIGS. 5 and 6, the upper shell of a housing 11 of the bottle fixing 10 is hidden in order to show the interior of the bottle fixing 10. FIG. 5 shows the bottle fixing from FIG. 4 in the fixed state. FIG. 6 shows the bottle fixing from FIG. 4 in the released state with the operating element 18 pressed in.

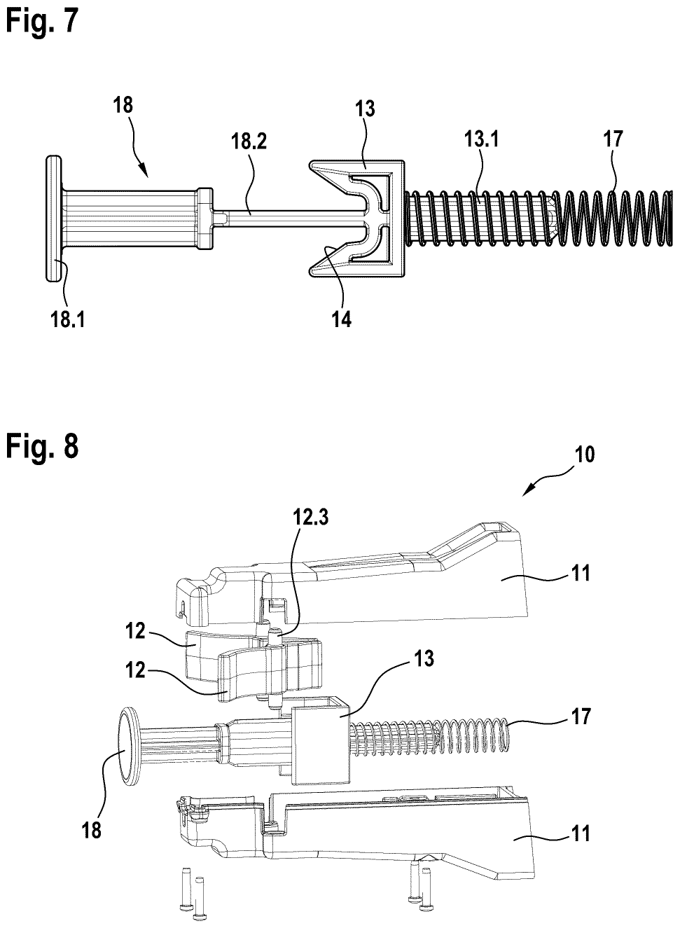

FIG. 7 shows a detail of the bottle fixing 10 and FIG. 8 shows an exploded illustration of the bottle fixing 10.

The bottle fixing 10 comprises two holding elements 12, which are rotatably mounted in the housing 11 via pivot bearings 12.3. Each holding element 12 comprises an outer lever portion 12.1 and an inner lever portion 12.2. The respective pivot bearing 12.3 is arranged between the outer lever portion 12.1 and the inner lever portion 12.2.

A blocking element 13 is mounted in the interior of the housing 11 linear movably. The blocking element 13 comprises an extension 13.1. A force accumulator 17 in the form of a spiral spring is arranged at this extension 13.1.

Between the blocking element 13 and the respective inner lever portion 12.2, there is an inclined plane arrangement 14, which leads to the two inner lever portions 12.2 being pushed inwards, when the blocking element 13 moves into the fixed state, causing the outer lever portions 12.1 to pivot outwardly and thereby fix the bottles 200 in a form-fitting manner.

Furthermore, the bottle fixing 10 comprises an operating element 18, which is composed of a head 18.1 and a connecting portion 18.2. The connecting portion 18.2 extends from the head 18.1 to the blocking element 13.

A finger can press on the head 18.1 in order to operate the bottle fixing 10. By pressing on the head 18.1, the bottle fixing 10 moves into the released state, wherein the force accumulator 17 is loaded.

FIG. 7 in particular illustrates that the operating element 18 together with the blocking element 13 forms a common component, in particular a common injection molding component.

FIGS. 5 and 6 show purely schematically the optional use of a stop arrangement 23 having a first stop surface at the operating element 18 and a second stop surface at the respective holding element 12; in particular, at the respective inner lever portion 12.2. The stop surfaces come into contact, when the operating element 18 is operated (see FIG. 6), causing the outer lever portions 12.1 to pivot inwardly.

Additively or alternatively, return springs 16, shown purely schematically, can be used in the section of the pivot bearing 12.3. These return springs 16 can also be used to set the holding elements 12 inserted in the released state in such a way that the bottles 20 can be.

Additively or alternatively, a further inclined plane arrangement 15, shown schematically, can also be used. In this case, a sliding contact is provided between the connecting portion 18.2 and the inner surfaces of the inner lever portions 12.2. In this way, when the operating element 18 is pressed in, it is possible to apply a force on the inner lever portions 12.2 in order to pivot the outer lever portions 12.1 inwards. This also allows the path for inserting a bottle 200 to be released.

FIGS. 4 and 5 show, purely schematically, the use of at least one optional locking element, as explained in the general part of the description.

Three different locking elements are described, of which preferably only one is used. However, two or all three of the locking elements can also be used at a bottle fixing 10.

The first locking element 19.1 is designed in particular to engage in a movement section of the bottle fixing 10 by means of electromotive or electromagnetic drive in order to lock the operation of the bottle fixing 10. In particular, the first locking element 19.1 can be used to lock a movement of the blocking element 13 and/or the operating element 18.

It is particularly preferred that the first locking element 19.1 is controllable for operating into the locked state and/or into the unlocked state. This is done in particular electrically or electronically. For controlling the first locking element 19.1, preferably a control device of the kitchen and/or catering device 100 is used. FIG. 5 shows this purely schematically.

The second locking element 19.2 comprises a locking cylinder in the operating element 18. By turning the locking cylinder with a key 24, a locking component can be extended out of the operating element 18 into the housing 11 in order to block a movement of the operating element 18 relative to the housing 11. FIG. 5 shows this purely schematically. FIG. 4 shows purely schematically the accessibility of the lock cylinder via the head 18.1 of the operating element 18.

The third locking element 19.3—shown purely schematically in FIG. 4—comprises a padlock that can be hung at the operating element 18 between the head 18.1 and the housing 11, wherein the shackle of the padlock blocks the operating element 18 from being pushed in.

In FIG. 6, the locking elements are not shown for the sake of lucidity.

In FIG. 3, the receptacles 3 of the solids units 2 are hidden. It can be seen that a bottle sensor 20 is arranged in the rear section of each solids unit 2. In the lower solids unit 2, the housing of the bottle sensor 20 is arranged so that the internal sensor pin 21 can be seen. This sensor pin 21 is operated by inserting the bottle 200 and by contact with the bottle 200, parallel to the inserting direction 4. It is possible to detect whether the respective bottle 200 is correctly inserted and far enough in by means of the bottle sensor 20.

Furthermore, FIG. 3 shows that a seal 22 is provided in each receptacle 3, through which an opening section of the respective bottle 200 can be pushed.

FIG. 9 shows, purely schematically, a side view and a front view of a kitchen and/or catering device 100, in which the assembly 1 is used.

The kitchen and/or catering device 100 is constructed as explained in the general part of the description. Accordingly, the kitchen and/or catering device 100 comprises a food chamber 101 and a collecting container 102 situated there beneath. A washing liquor line 103 leads to the food chamber 101 from the collecting container 102. A pump for pumping the washing liquor into the food chamber 101 can be arranged in this washing liquor line 103.

From the food chamber 101, the washing liquor can flow back into the collecting container 102 via a recirculation 110. A fresh water supply line 111 is provided to supply fresh water into the collecting container 102.

A corresponding line leads from the collecting container 102 to a supply line pump 104 and as far as the supply lines 5 of the solids units 2. The discharge lines 6 of the solids units 2 are connected to the collecting container 102 via lines.

Furthermore, FIG. 9 shows that the food chamber 101 is closed by a door 105. In the upper section of the kitchen and/or catering device 100 is an operating unit 106 for controlling the device.

A heating/recirculating unit 107 can be arranged in the food chamber 101.

FIG. 9 shows, purely schematically, that the assembly 1 arranged in the upper section can be closed by a flap 108. A flap element 109 can be formed as a sensor and/or as a closure. If the flap element 109 is formed as a sensor, it can detect whether the flap is closed. If the flap element 109 is formed as a closure, the flap can be closed in a controllable manner in order to allow or deny access to the bottles 200.

What is claimed is:

1. An assembly for arranging in a kitchen and/or catering device, in particular a cooking device, comprising:
at least one solids unit with:
a receptacle for inserting a bottle filled with solid additive along an inserting direction,
a supply line leading to the receptacle for supplying a fluid dissolving the additive, and
a discharge line leading from the receptacle for discharging the fluid together with the dissolved additive, and
at least one operable bottle fixing, which is designed to fix the at least one bottle in the respective receptacle in a fixed state and to release the at least one bottle for pulling out against the inserting direction in a released state.

2. The assembly of claim 1, wherein the bottle fixing comprises:
a housing, and
at least one holding element, which is movably, in particular rotatably, arranged at the housing,
wherein the holding element is designed to fix the bottle in a form-fitting and/or force-fitting manner in the fixed state, in particular to abut against the bottle or is designed to operate a further device in the fixed state, which fixes the bottle in a form-fitting and/or force-fitting manner.

3. The assembly of claim 2, wherein the bottle fixing comprises two of the holding elements for two bottles and a common blocking element for blocking both holding elements.

4. The assembly of claim 3, wherein the bottle fixing comprises a blocking element, which is movably, in particular linear movably, arranged at the housing,
wherein the blocking element is designed to block, in particular to block in a form-fitting manner, a movement of the at least one holding element in the fixed state and to release the movement of the at least one holding element in the released state.

5. The assembly of claim 4, wherein the at least one holding element comprises an outer lever portion and an inner lever portion and is rotatably mounted in the housing between the outer lever portion and the inner lever portion, wherein the inner lever portion is in contact with the blocking element in the fixed state.

6. The assembly of claim 5, wherein an inclined plane arrangement is formed between the blocking element and the inner lever portion for urging the holding element into the state of fixing the bottle.

7. The assembly of claim 6, wherein the at least one holding element in the released state can be urged into the state of releasing the bottle by means of a stop arrangement and/or a return spring and/or a further inclined plane arrangement.

8. The assembly of claim 7, wherein:
the bottle fixing comprises a force accumulator, in particular designed as a spring, and
the force accumulator urges the bottle fixing into the fixed state.

9. The assembly of claim 8, wherein the bottle fixing comprises an operating element designed to set the bottle fixing to the released state, preferably, wherein:
the operating element is arranged and designed for manual, tool-free operation, and/or
the operating element is arranged linear movable in the housing, and/or
the operating element is designed to shift the common blocking element, and/or
the operating element and the common blocking element are manufactured together as one part, and/or
the operating element comprises a head and a connecting portion, wherein the connecting portion projects from the head up to the common blocking element, in particular wherein the at least one holding element is arranged between the head and the common blocking element, and/or
the common blocking element comprises an extension, at which the force accumulator, designed as a spiral spring, is arranged.

10. The assembly of claim 1, comprising two of the solids units, wherein the bottle fixing is arranged between the two solids units and is designed to simultaneously fix both bottles in the fixed state and/or to simultaneously release both bottles in the released state.

11. The assembly of claim 1, wherein the receptacle of the at least one solids unit is designed for threadless inserting of the bottle.

12. The assembly of claim 1, wherein the bottle fixing comprises a locking element that can be in a locked state and an unlocked state, the locking element is designed to lock an operation of the bottle fixing into the released state, when the locking element is in the locked state, and not to lock an operation of the bottle fixing into the released state, when the locking element is in the unlocked state.

13. The assembly of claim 12, wherein the locking element, namely first locking element, is controllable for operating into the locked state and/or into the unlocked state, in particular is electrically or electronically controllable.

14. A kitchen and/or catering device, in particular cooking device, comprising
a food chamber for treating and/or storing food, in particular designed as cooking chamber,
a collecting container for storing a liquid washing liquor,
a washing liquor line for supplying the washing liquor from the collecting container into the food chamber,
an assembly of claim 1, wherein the discharge line leads in particular in direction of the collecting container, and
at least one supply line pump for pumping the fluid, preferably the washing liquor, through the at least one supply line.
